(19) United States
(12) Patent Application Publication
(10) Pub. No.: US 2010/0273823 A1
(43) Pub. Date: Oct. 28, 2010

(54) Pesticide Composition Solution and Preparation Method Thereof

(75) Inventors: Jianyi Ma, Zhejiang (CN); Liqin Zhang, Zhejiang (CN)

Correspondence Address: GLOBAL IP SERVICES, 7285 W. Eagle Court, Winton, CA, 95388, US

(73) Assignee: ZHEJIANG FORESTRY COLLEGE, Lin-an, Hangzhou, Zhejiang (CN)

(21) Appl. No.: 12/809,747

(22) PCT Filed: Mar. 12, 2009
(86) PCT No.: PCT/CN09/00261

§ 371 Date: Jun. 21, 2010

(30) Foreign Application Priority Data
Mar. 14, 2008 (CN) 200810061171.X

(51) Int. Cl. A01N 43/90; A01P 7/00

(52) U.S. Cl. 514/285

(57) ABSTRACT

A pesticide composition solution is provided. The pesticide composition includes an effective amount of active ingredient according to the formula I and a pesticide adjuvant,

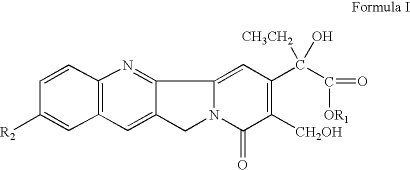

Wherein: R₁ is Na or K, and R₂ is H or OH. The pesticide composition solution in this invention can be processed using simple methods, does not require the use of organic solvents, can reduce environmental pollution, and will greatly lower pesticide production costs. In addition to the good pest control effect of the pesticide composition solution, the potassium salt contained in the solution can provide nutrients to crops, and promote plant growth. This pesticide composition solution is safe and reliable in use.

### FIELD OF THE INVENTION

The present patent relates to a pesticide derived from plant sources, and more particularly to a pesticide composition solution.

### BACKGROUND OF THE INVENTION

Camptothecin (CPT) is a pyrroloquinoline alkaloid that is mainly derived from Camptotheca acuminata, a plant endemic to China of the family Nyssaceae. Camptothecin was first isolated by Wall et al. in 1966 from Common Camptotheca Fruit wood introduced from China. Camptotheca acuminata is native to Jiangxi, Zhejiang, Hunan, Hubei, Sichuan, Yunnan, Guizhou, Guangdong, and Guangxi in China and contains camptothecin in its wood, roots, leaves, and fruit. Its alkaloids content is approximately 0.05% in roots and roughly 0.07-0.15% in leaves and fruit. Camptothecin is the chief alkaloid, but small quantities of hydroxycamptothecin and similar derivatives are also present. Research has found that camptothecin has some degree of short-term efficacy against malignant tumors, including tumors of the neck and head, bladder cancer, and leukemia. Hsiang et al. (1985) discovered that camptothecin and its derivatives can inhibit the synthesis of DNA via their targeted effect on topoisomerase I, giving them an anti-cancer effect. This study induced renewed attention to camptothecin. Many derivatives have since been isolated, and have become a major focal point of anti-cancer research. As many as seventy or eighty new derivatives have been reported to date. In general, two categories of derivatives are currently being used in clinical trials. One category is water-soluble derivatives like Irinotecan and Topotecan. Preclinical studies have proven that these derivatives are good topoisomerase inhibitors with effectiveness against most solid tumors in humans. Another category is derivatives insoluble in water, with 9-nitrocamptothecin and 9-aminocamptothecin as their representatives. Experiments have shown that these substances have greater anti-cancer activity than their parent compounds. It is clear that camptothecin and its derivatives have become a major focal point of medical research, particularly of research on anti-cancer drugs. However, because camptothecin is highly toxic to normal human cells, it cannot be used directly as an anti-cancer drug. There are limited reports in literature concerning the use of camptothecin and its derivatives as pesticides. For instance, CN 91103498.6 discloses a pesticide derived from camptothecin-containing plants and its manufacturing method. The invention chiefly involves the use of several types of alkaloid-containing plant tissues coarsely ground together in the following proportions: Common Camptotheca Fruit 33-36%, Macleaya cordata 3-5%, Common Threewingnut Root 7-12%, Winter Jasmine 3-6%, Ficus wightiana Wall 1-3%, and Pilea mollis 1-2%; and then they are dried, smash, extracted, filtered, and blended; the preparation also includes 5-11% additives and 30-36% water. The foregoing substances are all natural alkaloids poorly soluble in water, especially camptothecin. Because of this, the patent is difficult to carry out. Li has applied for a US patent (US 20020018762) for the use of camptothecin or a similar substance to control termites in wood. Our research has revealed that although camptothecin and its derivatives possess insecticidal activity, it is hard to bring them into industrial production because their extraction and manufacturing costs are very high as they are essentially insoluble in water and poorly soluble in other solvents commonly used for pesticides.

### SUMMARY OF THE INVENTION

Addressing the foregoing problems affecting the existing technology, the goal of the present invention is to find a mixed pesticide solution with good efficacy and provide a simple and low-costing preparation method thereof. This invention uses the sodium or potassium salt of camptothecin (or 10-hydroxycamptothecin) as the active insecticidal compound in an agricultural pesticide, and has successfully screened nine target pests.

The goal of the present invention is achieved through the following technological program:
1. A pesticide composition solution, comprising an effective amount of the active ingredient (s) according to formula I and pesticide adjuvant (s),

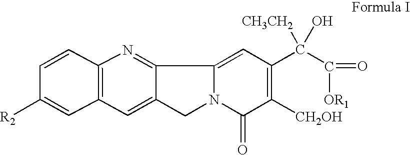

Wherein: R₁ is Na or K, R₂ is H or OH.

In a preferred example of the pesticide composition solution in the present invention, the foregoing active ingredient (s) constitutes 0.05-2.5% by weight of the pesticide composition solution and may be chosen from the sodium salt of open-ring camptothecin, the potassium salt of open-ring camptothecin, the sodium salt of open-ring 10-hydroxycamptothecin, or the potassium salt of open-ring 10-hydroxycamptothecin; the pesticide adjuvant constitutes 0.05-7.4% by weight of the pesticide composition solution, and selects from at least one of the following substances: calcium lignin benzenesulfonate, sodium lignosulfonate, sodium dodecylbenzene sulfonate, calcium dodecylbenzene sulfonate, sodium dodecylsulfate, and the wetting agent JFC.

In a preferred example of the pesticide composition solution in the present invention, the foregoing active ingredient (s) shall constitute 0.1-1.0% by weight of the pesticide composition solution.

In a more preferred example of the pesticide composition solution in the present invention, the foregoing active ingredient (s) shall constitute 0.1-0.5% by weight of the pesticide composition solution.

In a preferred example of the pesticide composition solution in the present invention, the foregoing pesticide adjuvant(s) shall constitute 0.1-5.0% of the weight of the pesticide composition solution.

In a more preferred example of the pesticide composition solution in the present invention, the foregoing pesticide adjuvant(s) shall constitute 2.0-5.0% of the weight of the pesticide composition solution.

In a preferred example of the pesticide composition solution in the present invention, the foregoing pesticide composition solution can be dehydrated to a dry powder. The mixture so obtained is more convenient to store and transport; when an amount of water equivalent to the dehydrated weight of the mixture is added, a pesticide composition solution with the original concentration can be reconstituted for using.

In a preferred example of the pesticide composition solution in the present invention, the foregoing pest may include planthoppers, aphids, chilo stem borers, yellow rice borers, rice leaf folders, tobacco whiteflies, empoasca vitis, diamondback moths, and cabbage caterpillar.

The present invention also provides a method for preparing the foregoing pesticide composition solution in the following steps:

(1) Camptothecin or 10-hydroxycamptothecin undergoes a ring-opening salt formation reaction in an alkaline sodium or potassium solution to yield a solution of the sodium or potassium salt of camptothecin or 10-hydroxycamptothecin; and

(2) A pesticide adjuvant is added to the solution obtained in step (1), which is stirred thoroughly to yield the pesticide composition solution.

In a preferred example of the pesticide composition solution preparation method, wherein the alkaline sodium or potassium solution in foregoing step (1) may consist of at least one of the aqueous solutions of the following substances: sodium hydroxide, potassium hydroxide, sodium phosphate, potassium phosphate, sodium carbonate, sodium bicarbonate, sodium edetate, sodium citrate, potassium carbonate, potassium bicarbonate, disodium hydrogen phosphate, dipotassium hydrogen phosphate, sodium dodecylbenzenesulfonate, sodium dodecylsulfate or sodium lignosulfonate; the solution's concentration may be 0.1-1.0 wt %. The technical parameters of the ring-opening salt formation reaction are that heating temperature from 25-75° C. and heating time from 2-24 hours. The amount of alkaline solution is 50-1,000 times in weight of an amount of camptothecin or 10-hydroxycamptothecin.

In a more preferred example of t the pesticide composition solution preparation method, the amount of the foregoing alkaline solution is 100-750 times in weight of an amount of camptothecin or 10-hydroxycamptothecin.

In the most preferred example of the pesticide composition solution preparation method, the amount of the foregoing alkaline solution is 200-500 times in weight of an amount of camptothecin or 10-hydroxycamptothecin.

In a preferred example of t the pesticide composition solution preparation method, the camptothecin or 10-hydroxycamptothecin in the foregoing step (1) is derived from dried or fresh Camptotheca acuminata (such as Camptotheca acuminata leaves, Camptotheca acuminata fruit, or branches), and the solution of the sodium or potassium salt of camptothecin or 10-hydroxycamptothecin so obtained must be concentrated to 0.05-1.0 times in weight of the dried Camptotheca acuminata before entering step (2).

In a preferred example of the pesticide composition solution preparation method, when the camptothecin or 10-hydroxycamptothecin in foregoing step (1) is derived from dried Camptotheca acuminata, the camptothecin or 10-hydroxycamptothecin can be added to alkaline solution with 5-30 times in weight of the dried Camptotheca acuminata, and can be added to alkaline solution with 10-20 times in weight of the dried Camptotheca acuminata in a more preferred example. The alkaline solution should preferably have a concentration of 0.2-0.8 wt %, and more preferably should have a concentration of 0.3-0.6 wt %.

In a preferred example of the pesticide composition solution preparation method, the foregoing concentration shall be achieved by using heat and pressure distillation under a heating temperature from 40-80° C. and a pressure from 0.05-0.55 Mpa.

In a preferred example of the pesticide composition solution preparation method, the amount of pesticide adjuvant added in step (2) is 2-8% in weight of the concentrated solution of the sodium or potassium salt of camptothecin or 10-hydroxycamptothecin obtained in step (1), and is 0.1-2.0% in weight of the concentrated solution obtained in step (1) in a more preferred example.

The foregoing fresh Camptotheca acuminata shall be dried under a heating temperature from 80-105° C., and preferably dried under a heating temperature from 90-100° C. to produce dried Camptotheca acuminata. The weight of dried Camptotheca acuminata shall be equivalent with one-fifth of the weight of fresh Camptotheca acuminata.

In a preferred example, the preparation method of the pesticide composition solution in the present invention is characterized in that the pesticide composition solution obtained in step (2) can be dehydrated and processed into a dry powder. The mixture so obtained is more convenient to store and transport; when an amount of water equivalent to the dehydrated weight of the mixture is added, a pesticide composition solution with the original concentration can be reconstituted for using.

In comparison with existing technology, the present invention possesses the following advantages:

The pesticide composition solution in the present invention employs a salt of open-ring camptothecin (or 10-hydroxycamptothecin) as its active insecticidal ingredient; the camptothecin salt is not only highly active, but is also soluble in water, and can be made using simple processing methods, thus greatly reducing the pesticide manufacturing costs. Furthermore, the invention's preparation method does not require the use of organic solvents, and can therefore reduce environmental pollution. In addition to its pest control effect, the pesticide composition solution prepared in this invention also contains potassium salts which can provide nutrients to crops and promote plant growth. This pesticide composition solution is safe and reliable in using.

### DETAIL DESCRIPTION OF THE INVENTION

The examples summarized below provide a concrete explanation of the contents of this invention. It should be understood that the embodiments of this invention are by no means limited to the following examples; any form of adaptation and/or modification of this invention should be included within the scope of this invention's claims.

Unless specified, all portions and percentages of this invention shall be given in units of weight, and all equipment and raw materials can be purchased on the market or are commonly used in this industry.

### Preparation Example 1

Add 400 kg of aqueous sodium hydroxide solution with a concentration of 0.4% to a reaction vessel or stirring tank, and slowly add 0.5 kg camptothecin with a purity of 80%. Heat to 35° C. while constantly stirring to promote reaction (ring opening and salt formation reaction). After the camptothecin has dissolved fully, add 20 kg sodium dodecylbenzenesulfonate and stir thoroughly, yielding the final product—a pesticide composition solution.

Furthermore, subject the pesticide composition solution obtained above to distillation in order to remove water and obtain a dry powder; this kind of pesticide is more convenient to store and transport; before using, add an equivalent amount of water to reconstitute a pesticide composition solution with the original concentration.

### Preparation Example 2

Add 400 kg of aqueous potassium hydroxide solution with a concentration of 0.2% to a reaction vessel or stirring tank, and slowly add 0.2 kg 10-hydroxycamptothecin with a purity of 80%. Heat to 40° C. while constantly stirring to promote reaction (ring opening and salt formation reaction). After the camptothecin has dissolved fully, add 10 kg NP-10 (polyoxyethylene nonylphenyl ether) and stir thoroughly, yielding the final product—a pesticide composition solution.

Furthermore, subject the pesticide composition solution obtained above to distillation in order to remove water and obtain a dry powder; this kind of pesticide is more convenient to store and transport; before using, add an equivalent amount of water to reconstitute a pesticide composition solution with the original concentration.

### Preparation Example 3

Add 400 kg of aqueous potassium hydroxide solution with a concentration of 0.4% to a reaction vessel or stirring tank, and slowly add 0.4 kg camptothecin with a purity of 80% and 0.1 kg 10-hydroxycamptothecin with a purity of 80%. Heat to 40° C. while constantly stirring to promote reaction (ring opening and salt formation reaction). After the camptothecin has dissolved fully, add 30 kg sodium dodecylsulfate and stir thoroughly, yielding the final product—a pesticide composition solution.

Furthermore, subject the pesticide composition solution obtained above to distillation in order to remove water and obtain a dry powder; this kind of pesticide is more convenient to store and transport; before using, add an equivalent amount of water to reconstitute a pesticide composition solution with the original concentration.

### Preparation Example 4

Place 180 kg fresh Camptotheca acuminata leaves in a plant grinding machine and grind for 10 minutes to obtain slurry. Add 220 kg of aqueous sodium dodecylbenzenesulfonate solution with a concentration of 0.1%, and continue to grind for 10 minutes. Heat to 45° C. while constantly stirring to promote reaction (ring opening and salt formation reaction) for 5 hours, and use a 200 mesh centrifuge to separate the solid and liquid. Collect the liquid portion, and perform reduced pressure distillation at 0.1 MPa and 60° C. to concentrate the solution to 10 kg. Add 0.2 kg JFC and stir thoroughly, yielding the final product—a pesticide composition solution.

Furthermore, subject the pesticide composition solution obtained above to distillation in order to remove water and obtain a dry powder; this kind of pesticide is more convenient to store and transport; before using, add an equivalent amount of water to reconstitute a pesticide composition solution with the original concentration.

### Preparation Example 5

Place 30 kg dried Camptotheca acuminata leaves in a plant grinding machine and grind to obtain 150 meshes. Add 300 kg of aqueous potassium hydroxide solution with a concentration of 0.1%. Heat to 40° C. while constantly stirring to promote reaction (ring opening and salt formation reaction) for 8 hours, and use a centrifuge to separate the solid and liquid. Collect the liquid portion, and perform reduced pressure distillation at 0.05 MPa and 50° C. to concentrate the solution to 10 kg. Add 0.8 kg sodium lignin benzenesulfonate and stir thoroughly, yielding the final product—a pesticide composition solution.

Furthermore, subject the pesticide composition solution obtained above to distillation in order to remove water and obtain a dry powder; this kind of pesticide is more convenient to store and transport; before using, add an equivalent amount of water to reconstitute a pesticide composition solution with the original concentration.

### Preparation Example 6

Place 60 kg fresh Camptotheca acuminata fruit in a plant grinding machine and grind to obtain 50 meshes. Add 400 kg of aqueous dipotassium hydrogen phosphate solution with a concentration of 0.3%.Heat to 50° C. while constantly stirring to promote reaction (ring opening and salt formation reaction) for 10 hours, and use a centrifuge to separate the solid and liquid. Collect the liquid portion, and perform reduced pressure distillation at a pressure of 0.10 MPa and temperature of 60° C. to concentrate the solution to 1.5 kg. Add 0.5 kg calcium lignosulfonate and stir thoroughly, yielding the final product—a pesticide composition solution.

Furthermore, subject the pesticide composition solution obtained above to distillation in order to remove water and obtain a dry powder; this kind of pesticide is more convenient to store and transport; before using, add an equivalent amount of water to reconstitute a pesticide composition solution with the original concentration.

### Preparation Example 7

Place 30 kg dried Camptotheca acuminata fruit in a plant grinding machine and grind to obtain 100 meshes. Add 400 kg of aqueous sodium hydroxide solution with a concentration of 0.6%. Heat to 30° C. while constantly stirring to promote reaction (ring opening and salt formation reaction) for 10 hours, and use a centrifuge to separate the solid and liquid. Collect the liquid portion, and perform reduced pressure distillation at 0.15 MPa and 65° C. to concentrate the solution to 3.5 kg. Add 0.2 kg sodium dodecylbenzenesulfonate and stir thoroughly, yielding the final product—a pesticide composition solution.

Furthermore, subject the pesticide composition solution obtained above to distillation in order to remove water and obtain a dry powder; this kind of pesticide is more convenient to store and transport; before using, add an equivalent amount of water to reconstitute a pesticide composition solution with the original concentration.

### Preparation Example 8

Place 30 kg dried Camptotheca acuminata branches in a plant grinding machine and grind to obtain 200 meshes. Add 400 kg of aqueous sodium lignin benzenesulfonate solution with a concentration of 0.6%. Heat to 30° C. while constantly stirring to promote reaction (ring opening and salt formation reaction) for 10 hours, and use a centrifuge to separate the solid and liquid. Collect the liquid portion, and perform reduced pressure distillation at 0.15 MPa and 75° C. to concentrate the solution to 3 kg. Add 0.06 kg JFC and stir thoroughly, yielding the final product—a pesticide composition solution.

Furthermore, subject the pesticide composition solution obtained above to distillation in order to remove water and obtain a dry powder; this kind of pesticide is more convenient to store and transport; before using, add an equivalent amount of water to reconstitute a pesticide composition solution with the original concentration.

### Composition Test Results for Preparation Examples 1-8 (Units: kg)

| | Test | | | | |
|---|---|---|---|---|---|
| | | | Total | | |
| | Amount of | Amount | Amount | | |
| Preparation | Active | of | of | % Active | % |
| Example | Ingredient | Adjuvant | Solution | Ingredient | Adjuvant |
| Preparation | 0.42 | 0.5 | 420.5 | 0.1 | 0.12 |
| Example 1 | | | | | |
| Preparation | 0.21 | 0.2 | 410.2 | 0.05 | 0.05 |
| Example 2 | | | | | |
| Preparation | 0.47 | 0.5 | 430.5 | 0.11 | 0.12 |
| Example 3 | | | | | |
| Preparation | 0.08 | 0.2 | 10.2 | 0.78 | 1.96 |
| Example 4 | | | | | |
| Preparation | 0.05 | 0.8 | 10.8 | 0.46 | 7.4 |
| Example 5 | | | | | |
| Preparation | 0.04 | 0.05 | 1.55 | 2.5 | 3.2 |
| Example 6 | | | | | |
| Preparation | 0.04 | 0.2 | 3.7 | 1.1 | 5.4 |
| Example 7 | | | | | |
| Preparation | 0.05 | 0.06 | 3.06 | 1.6 | 1.96 |
| Example 8 | | | | | |

### Efficacy Examples 1-9

When the pesticide solutions prepared in preparation examples 1-8 (with an active ingredient concentration of 2 mg/L) are applied to rice planthoppers, aphids, chilo stem borers, yellow rice borers, rice leaf folders, tobacco whiteflies, empoasca vitis, diamondback moths and cabbage caterpillar, the respective insecticidal effect will be as shown in tables 1-9.

TABLE 1
Insecticidal effect of solutions in preparation examples 1-8
on rice planthopper (active ingredient concentration 2 mg/L)

| | Efficacy of Treatment | | |
|---|---|---|---|
| | Prevention Efficacy % | | |
| Preparation | 3 Days after | 7 Days after | 14 Days after |
| Example | Administration | Administration | Administration |
| Preparation | 92.0 | 82.3 | 78.6 |
| Example 1 | | | |
| Preparation | 99.8 | 93.9 | 80.5 |
| Example 2 | | | |
| Preparation | 93.9 | 89.2 | 80.2 |
| Example 3 | | | |
| Preparation | 76.9 | 81.4 | 75.2 |
| Example 4 | | | |
| Preparation | 99.2 | 82.4 | 79.3 |
| Example 5 | | | |
| Preparation | 93.1 | 85.5 | 84.9 |
| Example 6 | | | |
| Preparation | 92.2 | 87.8 | 86.2 |
| Example 7 | | | |
| Preparation | 93.2 | 88.7 | 89.1 |
| Example 8 | | | |
| 48% Chlorpyrifos | 84.8 | 90.5 | 75.8 |
| EC Diluted | | | |
| 800 Times | | | |

TABLE 2
Insecticidal effect of solutions in preparation examples 1-8
on tea aphids (active ingredient concentration 2 mg/L)

| | Efficacy of Treatment | | |
|---|---|---|---|
| | Prevention Efficacy % | | |
| Preparation | 3 Days after | 7 Days after | 14 Days after |
| Example | Administration | Administration | Administration |
| Preparation | 84.7 | 94.6 | 82.1 |
| Example 1 | | | |
| Preparation | 80.4 | 94.4 | 81.4 |
| Example 2 | | | |
| Preparation | 82.7 | 93.1 | 81.5 |
| Example 3 | | | |
| Preparation | 80.9 | 98.5 | 78.8 |
| Example 4 | | | |
| Preparation | 79.7 | 88.9 | 76.7 |
| Example 5 | | | |
| Preparation | 75.3 | 81.3 | 76.3 |
| Example 6 | | | |
| Preparation | 84.2 | 88.5 | 81.3 |
| Example 7 | | | |
| Preparation | 79.2 | 84.2 | 86.1 |
| Example 8 | | | |
| 10% Imidacloprid | 68.2 | 73.5 | 75.4 |
| WP Diluted | | | |
| 1000 Times | | | |

TABLE 3
Insecticidal effect of solutions in preparation examples 1-8
on chilo stem borer (active ingredient concentration 2 mg/L)

| | Efficacy of Treatment | | |
|---|---|---|---|
| | Prevention Efficacy % | | |
| Preparation | 3 Days after | 7 Days after | 14 Days after |
| Example | Administration | Administration | Administration |
| Preparation | 82.1 | 86.3 | 75.2 |
| Example 1 | | | |
| Preparation | 76.0 | 84.5 | 73.6 |
| Example 2 | | | |
| Preparation | 75.0 | 85.6 | 73.3 |
| Example 3 | | | |
| Preparation | 72.2 | 85.2 | 70.1 |
| Example 4 | | | |
| Preparation | 76.3 | 87.9 | 70.5 |
| Example 5 | | | |
| Preparation | 65.4 | 77.4 | 62.4 |
| Example 6 | | | |
| Preparation | 78.2 | 82.4 | 69.8 |
| Example 7 | | | |
| Preparation | 75.3 | 79.4 | 81.2 |
| Example 8 | | | |
| 10% Imidacloprid | 71.1 | 84.5 | 70.6 |
| WP Diluted | | | |
| 1000 Times | | | |

TABLE 4
Insecticidal effect of solutions in preparation examples 1-8 on
rice yellow rice borer (active ingredient concentration 2 mg/L)

| | Efficacy of Treatment | | |
|---|---|---|---|
| | Prevention Efficacy % | | |
| Preparation | 3 Days after | 7 Days after | 14 Days after |
| Example | Administration | Administration | Administration |
| Preparation | 79.2 | 88.7 | 89.1 |
| Example 1 | | | |
| Preparation | 74.2 | 88.5 | 81.3 |
| Example 2 | | | |
| Preparation | 79.2 | 84.2 | 86.1 |
| Example 3 | | | |
| Preparation | 78.2 | 82.4 | 69.8 |
| Example 4 | | | |
| Preparation | 75.3 | 79.4 | 81.2 |
| Example 5 | | | |
| Preparation | 77.8 | 84.5 | 88.9 |
| Example 6 | | | |
| Preparation | 73.2 | 83.6 | 90.1 |
| Example 7 | | | |
| Preparation | 74.2 | 82.5 | 80.4 |
| Example 8 | | | |
| 10% Imidacloprid | 69.5 | 75.4 | 79.6 |
| WP Diluted | | | |
| 1000 Times | | | |

TABLE 5
Insecticidal effect of solutions in preparation examples 1-8
on rice leaf folder (active ingredient concentration 2 mg/L)

| | Efficacy of Treatment | | |
|---|---|---|---|
| | Prevention Efficacy % | | |
| Preparation | 3 Days after | 7 Days after | 14 Days after |
| Example | Administration | Administration | Administration |
| Preparation | 78.4 | 85.7 | 92.1 |
| Example 1 | | | |
| Preparation | 76.5 | 88.2 | 93.5 |
| Example 2 | | | |
| Preparation | 73.3 | 87.4 | 94.5 |
| Example 3 | | | |
| Preparation | 70.6 | 82.4 | 92.4 |
| Example 4 | | | |
| Preparation | 71.5 | 85.6 | 93.6 |
| Example 5 | | | |
| Preparation | 70.4 | 81.2 | 90.1 |
| Example 6 | | | |
| Preparation | 72.1 | 82.4 | 92.5 |
| Example 7 | | | |
| Preparation | 70.5 | 84.5 | 93.6 |
| Example 8 | | | |
| 10% Imidacloprid | 69.8 | 80.1 | 90.7 |
| WP Diluted | | | |
| 1000 Times | | | |

TABLE 6
Insecticidal effect of solutions in preparation examples 1-8 on
cabbage tobacco whitefly (active ingredient concentration 2 mg/L)

| | Efficacy of Treatment | | |
|---|---|---|---|
| | Prevention Efficacy % | | |
| Preparation | 3 Days after | 7 Days after | 14 Days after |
| Example | Administration | Administration | Administration |
| Preparation | 60.9 | 73.6 | 62.1 |
| Example 1 | | | |
| Preparation | 61.4 | 76.8 | 62.4 |
| Example 2 | | | |
| Preparation | 63.6 | 76.0 | 67.9 |
| Example 3 | | | |
| Preparation | 57.3 | 72.9 | 57.3 |
| Example 4 | | | |
| Preparation | 58.3 | 79.8 | 52.4 |
| Example 5 | | | |
| Preparation | 65.3 | 85.4 | 72.1 |
| Example 6 | | | |
| Preparation | 71.4 | 77.8 | 82.1 |
| Example 7 | | | |
| Preparation | 84.0 | 82.3 | 90.0 |
| Example 8 | | | |
| 10% Imidacloprid | 58.2 | 68.5 | 51.4 |
| WP Diluted | | | |
| 1000 Times | | | |

TABLE 7
Insecticidal effect of solutions in preparation examples 1-8 on
tea empoasca vitis (active ingredient concentration 2 mg/L)

| | Efficacy of Treatment | | |
|---|---|---|---|
| | Prevention Efficacy % | | |
| Preparation | 3 Days after | 7 Days after | 15 Days after |
| Example | Administration | Administration | Administration |
| Preparation | 75.1 | 80.8 | 75.3 |
| Example 1 | | | |
| Preparation | 62.1 | 84.0 | 73.9 |
| Example 2 | | | |
| Preparation | 64.0 | 79.6 | 74.3 |
| Example 3 | | | |
| Preparation | 63.3 | 77.8 | 77.3 |
| Example 4 | | | |
| Preparation | 64.5 | 77.3 | 70.8 |
| Example 5 | | | |
| Preparation | 56.8 | 82.1 | 76.5 |
| Example 6 | | | |
| Preparation | 68.4 | 87.4 | 82.0 |
| Example 7 | | | |
| Preparation | 84.1 | 88.5 | 81.6 |
| Example 8 | | | |
| 10% Imidacloprid | 58.1 | 62.4 | 59.1 |
| WP Diluted | | | |
| 1000 Times | | | |

TABLE 8
Insecticidal effect of solutions in preparation examples 1-8 on cabbage
diamondback moths (active ingredient concentration 2 mg/L)

| | Efficacy of Treatment | | |
|---|---|---|---|
| | Prevention Efficacy % | | |
| Preparation | 3 Days after | 7 Days after | 15 Days after |
| Example | Administration | Administration | Administration |
| Preparation | 81.4 | 89.8 | 81.3 |
| Example 1 | | | |
| Preparation | 82.6 | 92.8 | 80.4 |
| Example 2 | | | |
| Preparation | 79.5 | 91.4 | 74.6 |
| Example 3 | | | |
| Preparation | 75.6 | 88.4 | 80.2 |
| Example 4 | | | |
| Preparation | 73.4 | 79.8 | 75.4 |
| Example 5 | | | |
| Preparation | 74.4 | 84.2 | 80.1 |
| Example 6 | | | |
| Preparation | 81.3 | 80.0 | 84.5 |
| Example 7 | | | |
| Preparation | 79.8 | 84.5 | 87.3 |
| Example 8 | | | |
| 5% Chlorfluazuron | 68.7 | 72.8 | 70.4 |
| Emulsion Diluted | | | |
| 800 Times | | | |

TABLE 9
Insecticidal effect of solutions in preparation examples 1-8 on
cabbage caterpillar (active ingredient concentration 2 mg/L)

| | Efficacy of Treatment | | |
|---|---|---|---|
| | Prevention Efficacy % | | |
| Preparation | 3 Days after | 7 Days after | 15 Days after |
| Example | Administration | Administration | Administration |
| Preparation | 81.2 | 94.2 | 85.1 |
| Example 1 | | | |
| Preparation | 75.6 | 88.2 | 80.2 |
| Example 2 | | | |
| Preparation | 76.4 | 79.8 | 70.2 |
| Example 3 | | | |
| Preparation | 83.2 | 89.8 | 79.6 |
| Example 4 | | | |
| Preparation | 80.4 | 92.4 | 81.3 |
| Example 5 | | | |
| Preparation | 75.6 | 85.6 | 75.4 |
| Example 6 | | | |
| Preparation | 78.9 | 79.8 | 81.0 |
| Example 7 | | | |
| Preparation | 84.5 | 85.6 | 84.9 |
| Example 8 | | | |
| 20% Fenvalerate | 68.9 | 79.2 | 70.2 |
| Diluted | | | |
| 2000 Times | | | |

The test results in tables 1-9 clearly show that the solutions obtained in preparation examples 1-8 are highly effective at controlling agricultural/forestry pests including rice planthoppers, aphids, chilo stem borers, yellow rice borers, rice leaf folders, tobacco whiteflies, empoasca vitis, diamondback moths and cabbage caterpillar when the active ingredient concentration is 2 mg/L. Among the solutions in preparation examples 1-8, any one example displays more or less insecticidal activity against different pests. To achieve complete control of the foregoing pests, the pesticide application form (active ingredient content) and dilution multiple can therefore be adjusted during production and use.

The present invention is a biological pesticide, and possesses excellent environmental compatibility. In order to further reduce the harmful environmental impact of this agent, the input of artificial synthetic chemicals during the actual embodiment process can be reduced as much as possible. For instance, in consideration of environmental factors, the chemical pesticide adjuvant in this invention can be reduced to zero, or only a very small quantity can be added. For instance, the pesticide adjuvant content in preparation examples 1-3 is only 0.05-0.11%. This will facilitate reduction of the environmental pollution caused by pesticides. While, normal amounts of pesticide adjuvant employed in pesticide manufacturing are used in preparation examples 4-8.

1. A pesticide composition solution, comprising an effective amount of active ingredient according to the formula I and a pesticide adjuvant, 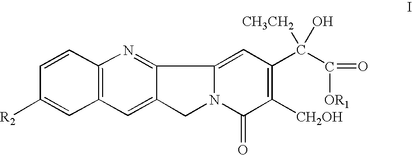
Wherein: R₁ is Na or K, and R₂ is H or OH.

2. The pesticide composition solution of claim 1, wherein the active ingredient is 0.05-2.5% by weight of the pesticide composition solution and is selected from a group consisting of open-ring camptothecin sodium salt, open-ring camptothecin potassium salt, open-ring 10-hydroxycamptothecin sodium salt or open-ring 10-hydroxycamptothecin potassium salt; wherein the pesticide adjuvant is 0.05-7.4% by weight of the pesticide composition solution and is at least one selected from a group consisting of calcium lignin benzenesulfonate, sodium lignosulfonate, sodium dodecylbenzene sulfonate, calcium dodecylbenzene sulfonate, sodium dodecylsulfate and wetting agent JFC.

3. The pesticide composition solution of claim 1, wherein the pesticide composition solution becomes a dry powder after dehydration.

4. The pesticide composition solution of claim 1, wherein the pest comprises planthoppers, aphids, Chilo stem borers, yellow rice borers, rice leaf folders, tobacco whiteflies, Empoasca vitis, diamondback moths and Cabbage caterpillar.

5. A method for preparing the pesticide composition solution of claims 1 including the following steps:
(1) yielding a solution of sodium or potassium salt of camptothecin or 10-hydroxycamptothecin by reacting camptothecin or 10-hydroxycamptothecin with an alkaline sodium or potassium solution in a ring-opening salt formation reaction; and
(2) Adding a pesticide adjuvant to the solution obtained in step (1) and yielding the pesticide composition solution by thoroughly stirring.

6. The method of claim 5, wherein the alkaline sodium or potassium solution in step (1) contains at least one selected from solutions of sodium hydroxide, potassium hydroxide, sodium phosphate, potassium phosphate, sodium carbonate, sodium bicarbonate, sodium edetate, sodium citrate, potassium carbonate, potassium bicarbonate, disodium hydrogen phosphate, dipotassium hydrogen phosphate, sodium dodecylbenzenesulfonate, sodium dodecylsulfate and sodium lignosulfonate with a concentration of 0.1-1.0 wt %; technical parameters of the ring-opening salt formation reaction are that heating temperature from 25-75° C., heating time from 2-24 hours, and an amount of the alkaline solution is 50-1,000 times in weight of an amount of camptothecin or 10-hydroxycamptothecin.

7. The method of claim 5, wherein camptothecin or 10-hydroxycamptothecin in step (1) is derived from fresh or dried Camptotheca acuminata, the solution of the sodium or potassium salt of camptothecin or 10-hydroxycamptothecin so obtained is concentrated to 0.05-1.0 times in weight of the dried Camptotheca acuminata before entering step (2)

8. The method of claim 7, wherein the solution of the sodium or potassium salt of camptothecin or 10-hydroxycamptothecin so obtained is concentrated by using heat and pressure distillation under a heating temperature from 40-80° C., and a pressure from 0.05-0.55 Mpa.

9. The method of claim 7, wherein the amount of the pesticide adjuvant in step (2) is 2-8% in weight of the concentrated solution of the sodium or potassium salt of camptothecin or 10-hydroxycamptothecin in step (1).

10. The method of claim 5, wherein dehydrate the pesticide composition solution obtained in step (2) to get dry powder of the pesticide composition solution.
